(19) United States
(12) Patent Application Publication
(10) Pub. No.: US 2025/0173745 A1
(43) Pub. Date: May 29, 2025

(54) System and Method for the Intelligent Utilization of Renewable Energy Enabled by IoT Sensor Data Analysis

(71) Applicant: International Business Machines Corporation, Armonk, NY (US)

(72) Inventors: Hamid Majdabadi, OTTAWA (CA); NEIL DELIMA, Scarborough (CA); Su Liu, Austin, TX (US); Jeremy R. Fox, Georgetown, TX (US)

(21) Appl. No.: 18/520,698

(22) Filed: Nov. 28, 2023

(51) Int. Cl. G06Q 30/0202; G06Q 30/0201; G06Q 30/04; G06Q 50/06

(52) U.S. Cl. CPC G06Q 30/0202; G06Q 30/0206; G06Q 30/04; G06Q 50/06

(57) ABSTRACT

Energy flow control is provided, which includes obtaining real time power generation data for each of one or more energy source nodes and obtaining real time power consumption data for one or more energy sink nodes. Further, predicted power consumption data is obtained for the one or more energy sink nodes, and predicted power generation data is obtained for each of one or more energy source nodes. Predicted allocation data is determined based at least on the predicted power consumption data, and the predicted power generation data. Actual allocation data is further determined based on the real time power consumption data, the real time power generation data, the predicted power consumption data, and the predicted power generation data. The actual allocation data is used for generating a first control signal.

### BACKGROUND

The present disclosure relates to energy flow control, and more specifically, systems and methods for energy flow control.

Utilization of renewable resources, for example, solar energy, wind power, hydroelectricity power, and biomass have become increasingly vital in a modern world to overcome challenges associated with climate change, resource depletion, and environmental degradation. In day-to-day life, the renewable resources have found extensive applications across diverse sectors. For example, solar panels and wind turbines are used to generate electricity form sun and wind, respectively. Electric vehicles powered by the renewable resources are steadily gaining popularity as a sustainable alternative to fossil fuel based transportation.

However, variations in energy generation for renewable resources may lead to various problems, for example, grid instability, intermittency, energy storage costs, resource dependency, energy demand mismatch, and the like.

### SUMMARY

One embodiment of the present disclosure provides a computer-implemented method that includes obtaining real time power generation data for each of one or more energy source nodes, which are configured to generate energy. The computer-implemented method further includes obtaining real time power consumption data for one or more energy sink nodes, which are configured to consume the generated energy. The computer-implemented method further includes obtaining predicted power consumption data for the one or more energy sink nodes and obtaining predicted power generation data for each of the one or more energy source nodes. The computer-implemented method further includes determining predicted allocation data corresponding to at least one of the one or more energy source nodes based on at least one of the predicted power consumption data, and the predicted power generation data. The predicted allocation data includes (i) identification data of at least one energy source node from the one or more energy source nodes, and (ii) an energy amount to be drawn from the at least one energy source node associated with the identification data. The computer-implemented method further includes determining actual allocation data corresponding to the at least one of the one or more energy source nodes based on the real time power consumption data, the real time power generation data, the predicted power consumption data, and the predicted power generation data. The computer-implemented method further includes generating, based on the actual allocation data, a first control signal for the at least one energy source node associated with the identification data. Further aspects of the present disclosure are directed to systems and computer program products containing functionality consistent with the method described above.

Another embodiment of the present disclosure provides a system that includes a processing circuitry configured to obtain real time power generation data for each of one or more energy source nodes, which are configured to generate energy. The processing circuitry may be further configured to obtain real time power consumption data for one or more energy sink nodes, which are configured to consume the generated energy. The processing circuitry may be further configured to determine predicted power consumption data for the one or more energy sink nodes based on at least one of energy sink data, and first predicted data. The processing circuitry may be further configured to determine predicted power generation data for each of the one or more energy source nodes based on at least one energy source data, and second predicted data. The processing circuitry may be further configured to determine predicted allocation data corresponding to at least one of the one or more energy source nodes based on at least one of the predicted power consumption data, and the predicted power generation data. The predicted allocation data includes (i) identification data of at least one energy source node from the one or more energy source nodes, and (ii) an energy amount to be drawn from the at least one energy source node associated with the identification data. The processing circuity may be further configured to determine actual allocation data corresponding to the at least one of the one or more energy source nodes based on the real time power consumption data, the real time power generation data, the predicted power consumption data, and the predicted power generation data. The processing circuitry may be further configured to generate, based on the actual allocation data, a first control signal for the at least one energy source node associated with the identification data.

Another embodiment of the present disclosure provides a computer program product for energy flow control. The computer program product includes a computer readable storage medium having program instructions, which when executed by a system, causes the system to obtain real time power generation data for each of one or more energy source nodes, which are configured to generate energy. The program instructions executed by the system may further cause the system to obtain real time power consumption data for one or more energy sink nodes, which are configured to consume the generated energy. The program instructions executed by the system may further cause the system to obtain predicted power consumption data for the one or more energy sink nodes. The program instructions executed by the system may further cause the system to obtain predicted power generation data for each of the one or more energy source nodes. The program instructions executed by the system may further cause the system to determine predicted allocation data corresponding to at least one of the one or more energy source nodes based on at least one of the predicted power consumption data, and the predicted power generation data. The predicted allocation data includes (i) identification data of at least one energy source node from the one or more energy source nodes, and (ii) an energy amount to be drawn from the at least one energy source node associated with the identification data. The program instructions executed by the system may further cause the system to determine actual allocation data corresponding to the at least one of the one or more energy source nodes based on the real time power consumption data, the real time power generation data, the predicted power consumption data, and the predicted power generation data. The program instructions executed by the system may further cause the system to generate, based on the actual allocation data, a first control signal for the at least one energy source node associated with the identification data.

### BRIEF DESCRIPTION OF DRAWINGS

The following description will provide details of preferred embodiments with reference to the following figures, wherein:

FIG. 1 is a diagram that illustrates a computing environment 100, in accordance with one or more example embodiments;

FIG. 2 is a diagram illustrating an energy flow environment in which a system for an energy flow control is implemented, in accordance with one or more example embodiments;

FIG. 3 is a block diagram of an exemplary energy node controller, in accordance with one or more example embodiments;

FIG. 4 is a block diagram illustrating an exemplary embodiment of the system for the energy flow control, in accordance with one or more example embodiments;

FIG. 5 is a flowchart for implementation of an exemplary method for the energy flow control, in accordance with one or more example embodiments;

FIG. 6 is a block diagram illustrating another example embodiment of the system for the energy flow control, in accordance with one or more example embodiments; and

FIG. 7 is a diagram that illustrates an example embodiment of training of a machine learning model used for at least one of determination of predicted power consumption data, and determination of predicted power generation data, in accordance with one or more example embodiments.

### DETAILED DESCRIPTION

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

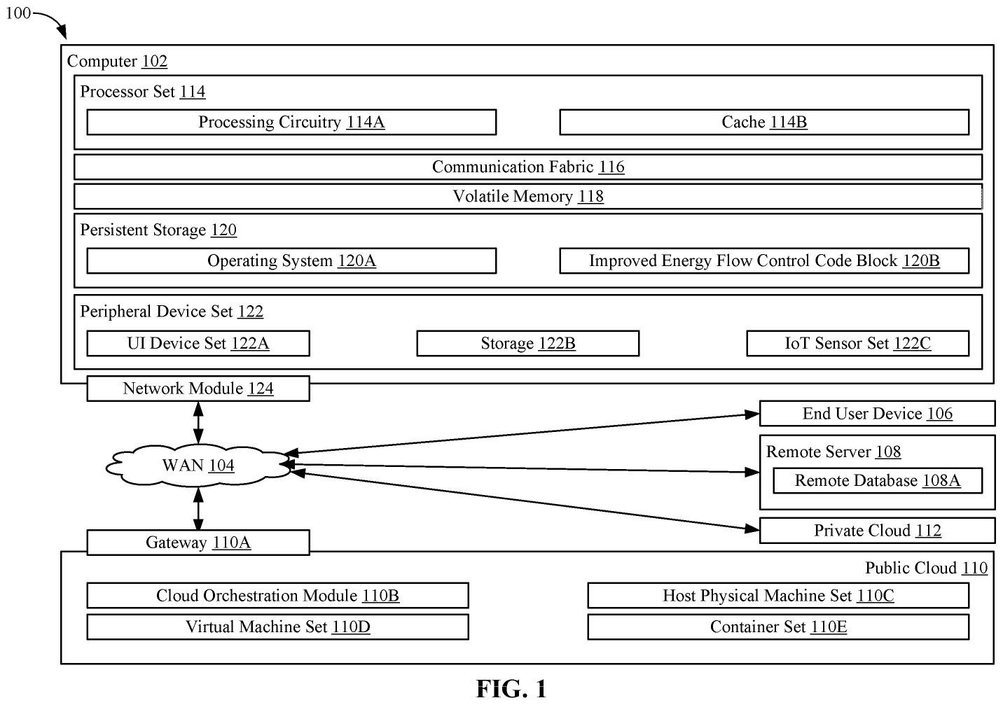

FIG. 1 illustrates a computing environment 100 which contains an exemplary environment for execution of at least some of a computer code involved in performing inventive methods, such as an improved energy flow control code block 120B. In addition to the block 120B, the computing environment 100 includes, for example, a computer 102, a wide area network (WAN) 104, an end user device (EUD) 106, a remote server 108, a public cloud 110, and a private cloud 112. In this embodiment, the computer 102 includes a processor set 114 (including a processing circuitry 114A and a cache 114B), a communication fabric 116, a volatile memory 118, a persistent storage 120 (including an operating system 120A and the block 120B, as identified above), a peripheral device set 122 (including a user interface (UI) device set 122A, a storage 122B, and an Internet of Things (IoT) sensor set 122C), and a network module 124. The remote server 108 includes a remote database 108A. The public cloud 110 includes a gateway 110A, a cloud orchestration module 110B, a host physical machine set 110C, a virtual machine set 110D, and a container set 110E.

The computer 102 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as the remote database 108A. As is well understood in the art of computer technology, and depending upon the technology, performance of a computer-implemented method may be distributed among multiple computers and/or between multiple locations. On the other hand, in this presentation of the computing environment 100, detailed discussion is focused on a single computer, specifically the computer 102, to keep the presentation as simple as possible. The computer 102 may be located in a cloud, even though it is not shown in a cloud in FIG. 1. On the other hand, the computer 102 is not required to be in a cloud except to any extent as may be affirmatively indicated.

The processor set 114 includes one, or more, computer processors of any type now known or to be developed in the future. The processing circuitry 114A may be distributed over multiple packages, for example, multiple, coordinated integrated circuit chips. The processing circuitry 114A may implement multiple processor threads and/or multiple processor cores. The cache 114B may be memory that is located in the processor chip package(s) and is typically used for data or code that should be available for rapid access by the threads or cores running on the processor set 114. Cache memories are typically organized into multiple levels depending upon relative proximity to the processing circuitry 114A. Alternatively, some, or all, of the cache 114B for the processor set 114 may be located off chip. In some computing environments, the processor set 114 may be designed for working with qubits and performing quantum computing.

Computer readable program instructions are typically loaded onto the computer 102 to cause a series of operational steps to be performed by the processor set 114 of the computer 102 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as the cache 114B and the other storage media discussed below. The program instructions, and associated data, are accessed by the processor set 114 to control and direct performance of the inventive methods. In the computing environment 100, at least some of the instructions for performing the inventive methods may be stored in the block 120B in the persistent storage 120.

The communication fabric 116 is the signal conduction path that allows the various components of the computer 102 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

The volatile memory 118 is any type of volatile memory now known or to be developed in the future. Examples include dynamic type random access memory (RAM) or static type RAM. Typically, the volatile memory 118 is characterized by random access, but this is not required unless affirmatively indicated. In the computer 102, the volatile memory 118 is located in a single package and is internal to the computer 102, but, alternatively or additionally, the volatile memory 118 may be distributed over multiple packages and/or located externally with respect to the computer 102.

The persistent storage 120 is any form of non-volatile storage for computers that is now known or to be developed in the future. The non-volatility of this storage means that the stored data is maintained regardless of whether power is being supplied to the computer 102 and/or directly to the persistent storage 120. The persistent storage 120 may be a read only memory (ROM), but typically at least a portion of the persistent storage 120 allows writing of data, deletion of data and re-writing of data. Some familiar forms of the persistent storage 120 include magnetic disks and solid state storage devices. The operating system 120A may take several forms, such as various known proprietary operating systems or open source Portable Operating System Interface-type operating systems that employ a kernel. The code included in the block 120B typically includes at least some of the computer code involved in performing the inventive methods.

The peripheral device set 122 includes the set of peripheral devices of the computer 102. Data communication connections between the peripheral devices and the other components of the computer 102 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, the UI device set 122A may include components such as a display screen, speaker, microphone, wearable devices (such as goggles and smart watches), keyboard, mouse, printer, touchpad, game controllers, and haptic devices. The storage 122B is external storage, such as an external hard drive, or insert able storage, such as an SD card. The storage 122B may be persistent and/or volatile. In some embodiments, the storage 122B may take the form of a quantum computing storage device for storing data in the form of qubits. In embodiments where the computer 102 is required to have a large amount of storage (for example, where the computer 102 locally stores and manages a large database) then this storage may be provided by peripheral storage devices designed for storing very large amounts of data, such as a storage area network (SAN) that is shared by multiple, geographically distributed computers. The IoT sensor set 122C is made up of sensors that can be used in Internet of Things applications. For example, one sensor may be a thermometer and another sensor may be a motion detector.

The network module 124 is the collection of computer software, hardware, and firmware that allows the computer 102 to communicate with other computers through the WAN 104. The network module 124 may include hardware, such as modems or Wi-Fi signal transceivers, software for packetizing and/or de-packetizing data for communication network transmission, and/or web browser software for communicating data over the internet. In some embodiments, network control functions and network forwarding functions of the network module 124 are performed on the same physical hardware device. In other embodiments (for example, embodiments that utilize software-defined networking (SDN)), the control functions and the forwarding functions of the network module 124 are performed on physically separate devices, such that the control functions manage several different network hardware devices. Computer readable program instructions for performing the inventive methods can typically be downloaded to the computer 102 from an external computer or external storage device through a network adapter card or network interface included in the network module 124.

The WAN 104 is any wide area network (for example, the internet) capable of communicating computer data over non-local distances by any technology for communicating computer data, now known or to be developed in the future. In some embodiments, the WAN 104 may be replaced and/or supplemented by local area networks (LANs) designed to communicate data between devices located in a local area, such as a Wi-Fi network. The WAN 104 and/or LANs typically include computer hardware such as copper transmission cables, optical transmission fibres, wireless transmission, routers, firewalls, switches, gateway computers and edge servers.

The end user device (EUD) 106 is any computer system that is used and controlled by an end user (for example, a customer of an enterprise that operates the computer 102) and may take any of the forms discussed above in connection with the computer 102. The EUD 106 typically receives helpful and useful data from the operations of the computer 102. For example, in a hypothetical case where the computer 102 is designed to provide a recommendation to an end user, this recommendation would typically be communicated from the network module 124 of the computer 102 through the WAN 104 to the EUD 106. In this way, the EUD 106 can display, or otherwise present, the recommendation to an end user. In some embodiments, the EUD 106 may be a client device, such as thin client, heavy client, mainframe computer, desktop computer and so on.

The remote server 108 is any computer system that serves at least some data and/or functionality to the computer 102. The remote server 108 may be controlled and used by the same entity that operates the computer 102. The remote server 108 represents the machine(s) that collect and store helpful and useful data for use by other computers, such as the computer 102. For example, in a hypothetical case where the computer 102 is designed and programmed to provide a recommendation based on historical data, then this historical data may be provided to the computer 102 from the remote database 108A of remote server 108.

The public cloud 110 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of the public cloud 110 is performed by the computer hardware and/or software of the cloud orchestration module 110B. The computing resources provided by the public cloud 110 are typically implemented by virtual computing environments that run on various computers making up the computers of the host physical machine set 110C, which is the universe of physical computers in and/or available to the public cloud 110. The virtual computing environments (VCEs) typically take the form of virtual machines from the virtual machine set 110D and/or containers from the container set 110E. It is understood that these VCEs may be stored as images and may be transferred among and between the various physical machine hosts, either as images or after instantiation of the VCE. The cloud orchestration module 110B manages the transfer and storage of images, deploys new instantiations of VCEs and manages active instantiations of VCE deployments. The Gateway 110A is the collection of computer software, hardware, and firmware that allows the public cloud 110 to communicate through the WAN 104.

The VCEs can be stored as images. A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

The private cloud 112 is similar to the public cloud 110, except that the computing resources are only available for use by a single enterprise. While the private cloud 112 is depicted as being in communication with the WAN 104, in other embodiments a private cloud may be disconnected from the internet entirely and only accessible through a local/private network. A hybrid cloud is a composition of multiple clouds of diverse types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, the public cloud 110 and the private cloud 112 are both part of a larger hybrid cloud.

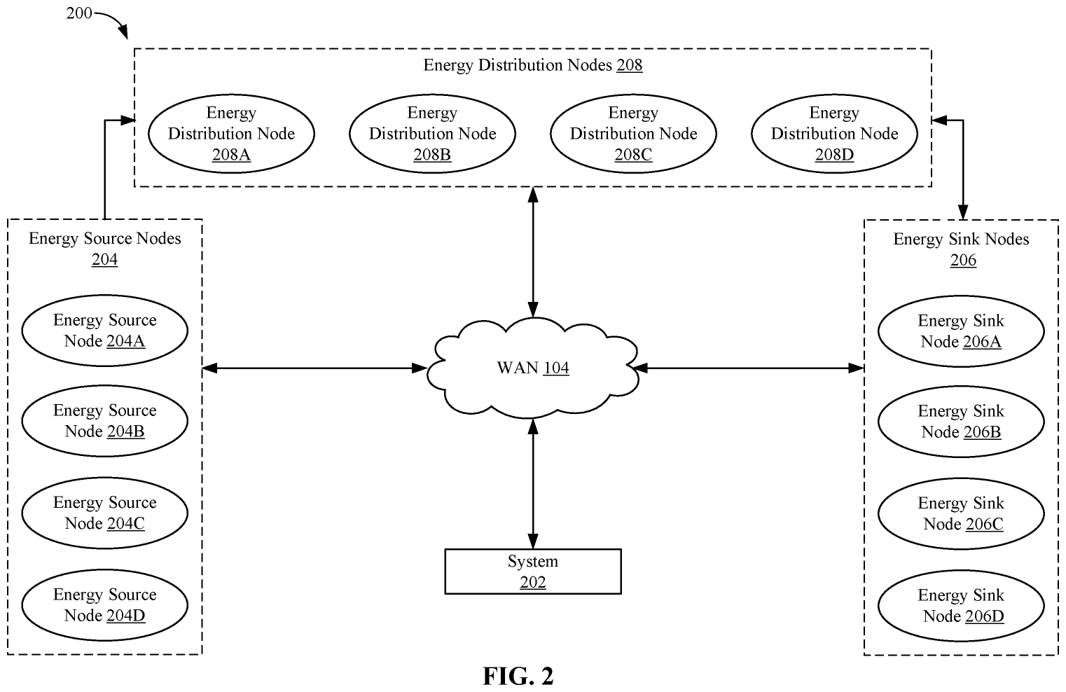

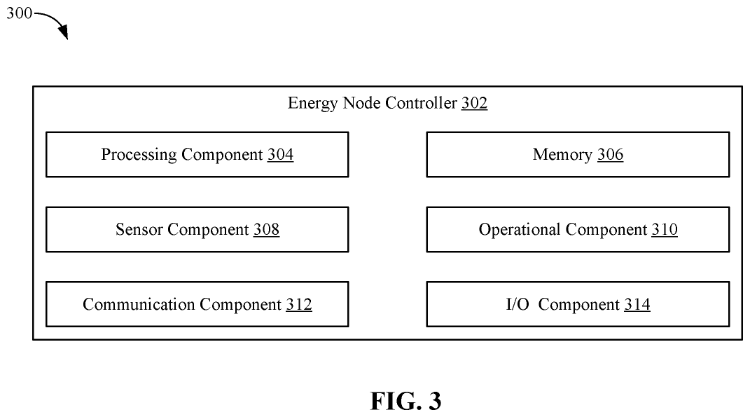

Referring back to FIG. 1, various components of the computing environment 100, for example the computer 102, the WAN, the EUD 106, the remote server 108, the public cloud 110, and the private cloud 112 may enable an execution of the at least some of the computer code, for example, the improved energy flow computer code block 120B for the energy flow control. Further, various components of the computer 102, for example, the processor set 114 or an instance of the processor set 114, for example, the processing circuitry 114A may execute the instructions of the improved energy flow computer code block 120B for the energy flow control. Further, the computer may use the cache 114B to increase a speed of data access operations. The volatile memory 118 may temporarily store several types of data that the computer 102 may use for the execution of the improved energy flow computer code 120B. The persistent storage 120 may store the operating system 120A, the improved energy flow computer code 120B and/or the several types of data. The peripheral devices set 122 may obtain the several types of data that the computer 102 may use for the execution of the improved energy flow computer code block 120B. The peripheral devices set 122 may provide an external storage to store the several types of data. Additionally, or alternatively, the peripheral devices set 122 may receive a user input for the execution of the improved energy flow computer code block 120B. The network module 124 may allow the computer 102 to communicate with components of an energy flow environment (explained with reference to FIG. 2 and FIG. 3) via the WAN 104 to obtain the several types of data for the execution of the improved energy flow computer code block 120B. Further, the remote server 108 may serve the several types of data and/or functionality, for example, recommendation functionality to the computer 102. The public cloud 110 and the private cloud 112 may provide on-demand computing resources and/or a cloud data storage to the computer 102 for the execution of the improved energy flow computer code 120B. Further, the EUD 106 may receive an output of the computer 102 that indicates the execution of the improved energy flow computer code 120B via a virtualization.

FIG. 2 is a diagram illustrating an energy flow environment 200 in which a system 202 for an energy flow control is implemented, in accordance with one or more example embodiments. The energy flow environment 200 may include the system 202, one or more energy source nodes 204, one or more energy sink nodes 206, one or more energy distribution nodes 208, and the WAN 104.

The one or more energy source nodes 204 may comprise an energy source node 204A, an energy source node 204B, an energy source node 204C, and an energy source node 204D. The one or more energy sink nodes 206 may comprise an energy sink node 206A, an energy sink node 206B, an energy sink node 206C, and an energy sink node 206D. The one or more energy distribution nodes 208 may comprise an energy distribution node 208A, an energy distribution node 208B, an energy distribution node 208C, and an energy distribution node 208D.

The system 202 is an exemplary embodiment of the computer 102. In an embodiment of the present disclosure, the system 202 may be embodied in one or more of several ways as per a required implementation. For example, the system 202 may be embodied as a cloud-based service or a cloud-based platform. In each of such embodiments, the system 202 may be communicatively coupled to the components shown in FIG. 2 to conduct desired operations and wherever required modifications may be possible within the scope of the present disclosure. The components, for example, the system 202, the one or more energy source nodes 204, the one or more energy sink nodes 206, the one or more energy distribution nodes 208 may be coupled with each other via the WAN 104.

In some embodiments, the system 202 may be stored in a main memory and/or on a mass storage, includes a kernel or an operating system, for example, the operating system 120A, a shell, and a user interface. One or more application programs, such as an application software, may be “loaded” (i.e., transferred from the mass storage into the main memory) for execution by a data-processing apparatus, for example, the processing circuitry 114A. The data-processing apparatus may receive user commands and data through the user interface.

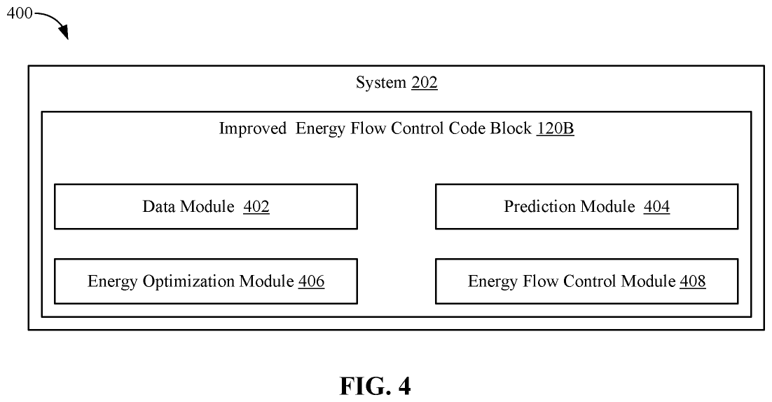

Further, in an embodiment of the present disclosure, the system 202 may correspond to a standalone unit configured to receive, transmit, validate, and store the various type of data associated with the components in the energy flow environment 200. The several types of data are further described with reference to FIG. 3, and FIG. 4.

In some example embodiments, the system 202 may correspond to an accessible device such as a mobile phone, a smartphone, a portable computer, and the like that are portable in themselves or as a part of another portable/mobile object such as a vehicle. The vehicle may include, but are not limited to, an autonomous vehicle, a semi-autonomous vehicle, or a manually driven vehicle. In an embodiment of the present disclosure, the system 202 may execute and run mobile applications such as a messaging application, a browser application, a navigation application, and the like.

Further, the one or more energy sources nodes 204 may generate energy based on one or more renewable resources, for example, solar energy, wind energy, geothermal energy, biomass energy, and the like. In some embodiment, the one or more energy source nodes 204 may be referred to as “one or more renewable energy source nodes”. Examples of the one or more renewable energy sources nodes may include, but are not limited to, photovoltaic panels, wind turbines, hydroelectric power plants, biomass power plants, geothermal power plants, ocean energy converters, and the like. Additionally, or alternatively, the one or more energy source nodes 204 may generate the energy based on one or more non-renewable resources, for example, coal, oil, natural gases, nuclear fuels, and the like. In some embodiments, the one or more energy source nodes 204 may be referred to as “one or more non-renewable energy source nodes”. Examples of the one or more non-renewable energy source nodes may include, but are not limited to, a coal plant, an oil refinery, a natural gas plant, a nuclear power plant, and the like.

Further, the one or more energy source nodes 204 may generate a first variable energy based on a first set of factors. The first set of factors may include, but are not limited to, weather conditions, geological factors, an equipment performance, an energy source type, transmission losses, and the like.

In an embodiment of the present disclosure, the energy source node 204A may generate the energy based on the solar energy. However, as a result of bad weather bad conditions, the energy source node 204A may generate a reduced energy amount. The bad weather conditions may include, but are not limited to, snowstorms, a fog, a heavy rain, and the like. Hence, in some embodiments, the system 202 may control an energy amount to be drawn from at least one energy source node, for example, the energy source node 204B of the one or more energy source nodes 204 to provide a constant energy supply to the one or more energy sink nodes 206.

Additionally or alternatively, the system 202 may feed the drawn energy amount to the one or more distribution nodes 208. Further, the one or more energy distribution nodes 208 may distribute the generated energy to the one or more energy sink nodes 206. Examples of the one or more distribution nodes 208 may include, but are not limited to, energy distribution grids, energy substations, energy distribution micro-grids, and the like.

Further, the one or more energy sink nodes 206 may consume the generated energy. Examples of the one or more energy sink nodes 206 may include, but are not limited to, residential homes, commercial buildings, industrial facilities, data centres, telecommunication facilities, and the like. Further, in an embodiment of the present disclosure, the one or more energy sink nodes 206 may consume a second variable energy based on a second set of factors. The second set of factors may include, but are not limited to, demand fluctuations, different times of day, economic factors, the weather conditions, an energy sink type, and the like.

In an embodiment of the present disclosure, the energy sink 206A may correspond to a facility. Further, the facility may consume the energy generated by the energy source node 204A. However, because of an increase in number of consumers at the facility, the facility may require an additional energy amount to provide one or more services to one or more consumers. The one or more services may include, but are not limited to, lighting services, heating services, ventilation services, air conditioning services, equipment services, security services, and the like. Hence, in some embodiment, the system 202 may control the energy amount to be drawn from the at least one energy source node, for example, the energy source node 204B.

In another embodiment of the present disclosure, as a result of a decrease in the number of consumers at the facility, the facility may consume less energy corresponding to the generated energy. Therefore, the system 202 may control an excess energy amount to be drawn from at least one energy sink node, for example, the energy sink node 206A of the one or more energy sink nodes 206. Further, the excess energy amount may indicate a difference between the generated energy and the consumed energy. Additionally or alternatively, the system 202 may control the energy sink node 206A to feed the excess energy amount to the one or more distribution nodes 208. Additionally or alternatively, the system 202 may control the one or more distribution nodes 208 to distribute the excess energy amount to a different energy sink node, for example, the energy sink node 206C.

Referring back to FIG. 2, the energy flow environment 200 may include one or more energy nodes, for example, the one or more energy source nodes 204 that generate the energy. The one or more energy sink nodes 206 that consume the generated energy. The one or more distribution nodes 208 that distribute the generated energy to the one or more sink nodes 206. Further, the energy flow environment 200 may include the system 202 that may control the energy amount to be drawn from the one or more energy source nodes 204. Further, the system 202 may distribute the drawn energy amount to the one or more energy sink nodes 206 via the one or more distribution nodes 208 to provide the constant energy supply. Further, the system may control the excess energy amount to be drawn from the one or more energy sink nodes 206. Further, the system may distribute the drawn excess energy amount to the one or more distribution nodes 208 and/or to the one or more energy sink nodes for an optimal energy utilization.

Further, in some embodiments, the one or more energy nodes, for example, the one or more energy source nodes 204, the one or more energy sink nodes 206, and the one or more energy distribution nodes 208, are connected to one or more energy node controllers. The one or more energy node controllers cause the execution of a control command determined based on the control signal generated by the system 202, for controlling the corresponding node connected to an energy node controller of the one or more energy node controllers. The one or more energy node controllers may perform one or more operations within the energy flow environment 200 in conjunction with the system 202. The one or more operations may include, but are not limited to, energy generation operations, energy consumption operations, energy distribution operations, communication operations and the like. An exemplary energy node controller is described below with reference to FIG. 3.

FIG. 3 is a block diagram 300 of an exemplary energy node controller 302, in accordance with one or more example embodiments. The exemplary energy node controller 302 may include a plurality of components, for example a processing component 304, a memory 306, a sensor component 308, an operational component 310, a communication component 312, and an input/output (I/O) component 314.

The processing component 304 may include one or more processors to execute instructions to perform the one or more operations. Additionally, processing component 304 may include one or more modules to facilitate interaction between the components. For example, the processing component 304 may include a communication module to facilitate interaction between the communication component 312 and the processing component 304. The processing component 304 causes execution of processing instructions, such as computer instructions, which cause provision of a control command to a node connected to the energy node controller 302.

In an embodiment of the present disclosure, the processing component 304 may be coupled with a power component. The power component may provide power to the plurality of components of the exemplary energy node controller 302. The power component may include a power management system, one or more power sources, and the like.

The memory 306 may store the processing instructions that are executable by the processing component 304 and any data that may be utilized by methods and systems of the present disclosure. The memory 306 may include, but are not limited to, a Static Random Access Memory (SRAM), an Electrically Erasable Programmable Read Only Memory (EEPROM), an Erasable Programmable Read Only Memory (EPROM), a Programmable Read Only Memory (PROM), a Read Only Memory (ROM), a Magnetic Memory, a Flash Memory, a Disk and an Optical Disk. The memory 306 may be a volatile memory unit or units, and/or a non-volatile memory units or units.

The energy node controller 302 is coupled to a corresponding node for controlling functioning of the corresponding node.

In an embodiment, the energy node controller 302 is connected a corresponding energy source node of the one or more energy source nodes 204. Pursuant to the present embodiment, the memory 306 stores energy source data associated with the corresponding energy source node of the one or more energy source nodes 204. The energy source data may include, but are not limited to, energy source type data, energy source power generation capacity data, energy source installation data, energy source location data, and environmental impact data.

The energy source type data may indicate a type of source that is utilized by the corresponding energy source node of the one or more energy source nodes 204 to generate the energy, for example, the solar energy, the wind energy, the geothermal energy, the biomass energy and the like. The energy source power generation capacity data may indicate a maximum power output of the corresponding energy source node of the one or more energy source nodes 204. In some embodiments, the maximum power output may be measured in units of power, such as megawatts (MW), gigawatts (GW), and the like. The energy source installation data may include, but are not limited to, an installation date, an energy source node operator, an energy source node model, and the like. The energy location data may indicate a location of the corresponding energy source node of the one or more energy source nodes 204. Additionally or alternatively, the energy source location data may indicate first real time weather conditions corresponding to the location of the corresponding energy source node of the one or more energy source nodes 204. The environmental impact data may include, but are not limited to, greenhouse gas emission data, water usage data, geospatial data, particulate matter data, resource usage data, waste generation data, and resource regulation data. The greenhouse emission data may indicate an emission of greenhouse gases, for example, carbon-dioxide, methane, and the like that the one or more energy source nodes 204 may emit to generate the energy. The water usage data may indicate a water usage that the corresponding energy source node of the one or more energy source nodes 204 may use to generate the energy. The geospatial data may indicate physical changes to landscape that may occur as a result of mining, fracking, and the like at the location of the corresponding energy source node of the one or more energy source nodes 204. The particulate matter data may indicate an amount of particles, for example, chemical pollutants, and the like that the corresponding energy source node of the one or more energy source nodes 204 may release to generate the energy. The resource usage data may indicate an amount of resource, for example, the coal, the natural gases, and the like that the corresponding energy source node of the one or more energy source nodes 204 may use to generate the energy. The waste generation data may indicate an amount of waste materials that the corresponding energy source node of the one or more energy source nodes 204 may generate after the resource usage. The resource regulation data may indicate regulations or guidelines corresponding to at least one of the resource usage, environmental impacts, and resource regulatory agencies, and the like. For example, the resource regulation data may indicate an acceptable level of emission of the chemical pollutants, the greenhouse gases, and the like.

In an embodiment of the present disclosure, based on the type of source, for example, the solar energy, the energy source data may further include short circuit current data, open circuit voltage data, maximum power point data, conversion efficiency data, angle of light data, operating temperature data, and the like. Further, the short circuit current data may indicate a maximum current that can flow through an electrical circuit when a fault occurs. The open circuit voltage data may indicate a voltage across the electrical circuit with no current flowing through the electrical circuit. The maximum power point data may indicate a specific operating point at which a solar panel may generate a maximum electrical power output when exposed to the solar energy. The conversion efficiency data may indicate an energy conversion amount, for example, the solar energy to an electrical energy conversion amount. The angle of light data may indicate an angle of light at which a light strikes the solar panel. The operating temperature data may indicate an operating temperature range at which the solar panel may operate effectively.

Further, in an embodiment, the energy node controller 302 is connected to a corresponding energy sink node of the one or more energy sink nodes 206. Pursuant to the present embodiment, the memory 306 may store energy sink data associated with the corresponding energy sink node of one or more energy sink nodes 206. The energy sink data may include, but are not limited to, energy sink type data, energy sink power consumption capacity data, energy sink location data, and conditional level consumption data.

The energy sink type data may indicate a type of sink that utilize the generated energy, for example, a commercial building, a residential home, a data centre, and the like. The energy source power consumption capacity data may indicate a maximum energy load that the corresponding energy sink node of one or more energy sink nodes 206 may draw from the one or more energy source nodes 204 and/or the one or more distribution nodes 208. The energy sink location data may indicate a location of the corresponding energy sink node of the one or more energy sink nodes 206. Additionally, or alternatively, the energy sink location data may indicate second real time weather conditions corresponding to the location of the corresponding energy sink node of one or more energy sink nodes 206. The conditional level consumption data may indicate an association between the number of consumers of the corresponding energy sink node of the one or more energy sink nodes 206 and one or more conditions. The one or more conditions may include, but are not limited to, public holidays, seasonal changes, various times of the day, special events, and the like.

The sensor component 308 may include one or more sensors for collecting various aspects of state assessment for the exemplary energy node controller 302. In some embodiments, the one or more sensors may be referred to as “one or more Internet of Things (IoT) sensors. The one or more sensors may include, but are not limited to, temperature sensors, light sensors, humidity sensors, motion sensors, gas sensors, smart energy meters, proximity sensors, acceleration sensors, voltage sensors, and the like.

The operational component 310 may include one or more operational components corresponding to the one or more operations performed by the exemplary energy node controller 302. The one or more operational components may include, but are not limited to, one or more energy generation components, one or more energy consumption components, one or more energy distribution components, and the like.

Further, the one or more energy generation components may convert the renewable resources into the energy, for example, the electrical energy. The one or more energy generation components may include, but are not limited to, photovoltaic cells, blades, hydroelectric generators, microbial fuel cells, tidal energy convertors, and the like.

Further, the one or more energy consumption components may consume the generated energy. Examples of the one or more energy consumption components may include, but are not limited to, heating components, cooling components, lighting components, ventilation components, energy transmission loss components, and the like.

Further, the one or more energy distribution components may distribute the generated energy. Additionally, or alternatively, the one or more energy distribution components may store the generated energy. The one or more energy distribution components may include, but are not limited to, transformers, circuit breakers, capacitors, reactors, voltage regulators, distribution lines, batteries, capacitors, pumped hydro storage, and the like.

The communication component 312 may enable a wired or a wireless communication between the exemplary energy node controller 302 and the system 202. The communication component 312 may access a wireless network based on a communication standard, such as Wi-Fi, 2G or 3G, or a combination thereof. In some embodiments, the communication component 312 may receive broadcast signals or broadcast associated information from an external broadcast management system via a broadcast channel.

In an embodiment of the present disclosure, the communication component 312 may further include a near field communication (NFC) module to facilitate short range communication. For example, the NFC module may be implemented based on a radio frequency identification (RFID) technology, an infrared data association (IrDA) technology, an ultra-wideband (UWB) technology, a Bluetooth (BT) technology, and the like. In an exemplary embodiment, the communication component 312 may be implemented by one or more application specific integrated circuits (ASICs), digital signal processors (DSPs), digital signal processing devices (DSPDs), programmable logic devices (PLDs), field programmable gate array (FPGA), and the like.

The I/O component 314 may include a screen to receive the user input or to display the output. In some embodiments, the screen may include a liquid crystal display (LCD) and a touch panel (TP). Further, the touch panel may include one or more touch sensors to sense touches, slides, and gestures on the touch panel. Further, the one or more touch sensors may be configured to determine a duration and a pressure associated with the touches, the slides, and the gestures. The I/O component 314 may provide an I/O interface between the processing component 304 and peripheral devices such as a keyboard, a click wheel, a button, and the like. The buttons may include, but are not limited to, a home button, a volume button, a start button, and a lock button.

Referring back to FIG. 3, various components of the exemplary energy node controller 302, for example, the processing component 304, the memory 306, the sensor component 308, the operational component 310, the communication component 312, and I/O component 314 may perform the one or more operations within the energy flow environment 200 in conjunction with the system 202. For example, the processing component 304 may execute the instructions to perform the one or more operations. In an embodiment of the present disclosure, the processing component 304 may retrieve the executable instructions from the memory 306. Additionally, or alternatively, the memory may store any data that may be utilized by methods and systems of the present disclosure. In an embodiment of the present disclosure, the sensor component 308 may obtain several types of data, for example, the energy source data, the energy sink data, and the like. Further, the memory 306 may store the several types of data that the system 202 may retrieve for the energy flow control. In an embodiment of the present disclosure, the system 202 may retrieve the several types of data by using the communication component 312. The communication component 312 may enable the wired or the wireless communication between the exemplary energy node controller 302 and the system 202. In an embodiment of the present disclosure, the I/O component 314 may receive the user input or display the output for the energy flow control.

In an embodiment of the present disclosure, each of the energy source nodes is connected to a corresponding energy node controller 302. The energy node controller 302 in this embodiment, is configured to control the sensor component 308 to obtain real time power generation data associated with the energy generated by the operational component 310 of the corresponding energy source node of the one or more energy source nodes 204, for example, the solar panel. This obtained real time power generation data is stored in the memory 306 and may be output by the I/O component 314 when requested. For example, the real time power generation data may be supplied to the one or more energy distribution nodes 208 to indicate how much energy each energy source node of the one or more energy source nodes 204 is generating. This may be used to plan the drawing and distribution of energy by the one or more energy distribution nodes.

To that end, the one or more energy nodes 208 may also be connected to a master energy node controller of the architecture of the energy node controller 302. This master energy node controller receives real time power generation data of each of the one or more energy source nodes 204 and distributes energy to the one or more energy sink nodes 206. The master energy node controller includes the processing component 304 which generates a set of control commands to control the operational component 310, for example, a transformer. Further, based on the set of control commands for the operational component 310, the energy node controller 302 may distribute the energy amount to the one or more energy sink nodes 206.

In an embodiment of the present disclosure, each of the one more energy sink nodes 206 is coupled to a corresponding energy node controller 302. Pursuant to the present embodiment, the processing component 304 may generate a set of control commands for the sensor component 308 to obtain the real time power consumption data associated with the energy consumed by the operational component 310 associated with the corresponding energy sink node of the one or more energy sink nodes 206. For example, the operational component 310 may be a heating component. The memory 306 may store the obtained real time power consumption data, which may be outputted by the I/O component 314, when requested. For example, the master energy node controller of the one or more energy distribution nodes may request the real time power consumption data from a corresponding energy sink node of the one or more energy sink nodes to allocate the energy to be distributed to the corresponding energy sink node.

Thus, the architecture of the energy node controller 302 may be implemented at any of the nodes of the energy flow control environment 200 to control the flow of energy based on energy data monitoring using the sensor component 308 of the energy node controller.

FIG. 4 is a block diagram illustrating an exemplary embodiment of the system 202 for the energy flow control, in accordance with one or more example embodiments. As shown by FIG. 4, the system 202 may include the improved energy flow control code block 120B. Further, the improved energy flow control code block 120B may include one or more processing modules, such as a data module 402, a prediction module 404, an energy optimization module 406, and an energy flow control module 408.

In accordance with an embodiment, the system 202 may store data that may be generated by the modules while performing corresponding operation. Further, the system may retrieve the data from a database associated with the system 202. Additionally or alternatively, the system may transmit the data to the database or the energy nodes within the energy flow environment 200.

In an embodiment of the present disclosure, the data module 402 may obtain real time power generation data for each of one or more energy source nodes 204. The real time power generation data may correspond to first instantaneous data associated with the generation of the energy. The real time power generation data may include at least one of energy source voltage data, energy source current data, energy source weather data, and the like. The energy source voltage data may indicate energy source voltage parameters, for example, an energy source phase-to-phase voltage parameter, an energy source phase-to-neutral voltage parameter, an energy source line voltage parameter, and the like. Further, the energy source voltage data may indicate energy source voltage variations measurements, for example, energy source voltage sags, energy source voltage surges, energy source harmonics, and the like. The energy source current data may indicate energy source current parameters, such as, energy source phase currents, energy source line currents, and the like. Further, the energy source current data may indicate an energy source current type, for example, an alternating current (AC) or a direct current (DC). Further, the energy source weather data indicate real time weather condition associated with the location of the one or more energy source nodes 204.

In an embodiment of the present disclosure, the data module 402 may obtain real time power consumption data for the one or more energy sink nodes 206. The real time power consumption data may correspond to second instantaneous data associated with the consumption of the energy. The real time power consumption data may include at least one of energy sink voltage data, energy sink current data, energy sink weather data, and the like. The energy sink voltage data may indicate energy sink voltage parameters, for example, an energy sink phase-to-phase voltage parameter, an energy sink phase-to-neutral voltage parameter, an energy sink line voltage parameter, and the like. Further, the energy sink voltage data may indicate energy sink voltage variations measurements, for example, energy sink voltage sags, energy sink voltage surges, energy sink harmonics, and the like. The energy source current data may indicate energy sink current parameters, such as, energy sink phase currents, energy sink line currents, and the like. Further, the energy source current data may indicate an energy current type, for example, the AC or the DC. Further, the energy sink weather data indicate real time weather condition associated with the location of the one or more energy sink nodes 206.

In an embodiment of the present disclosure, the data module 402 may obtain predicted power consumption data for the one or more energy sink nodes. Further, the predicted power generation consumption data indicate at least an anticipated energy consumption amount for the one or more energy sink nodes 206.

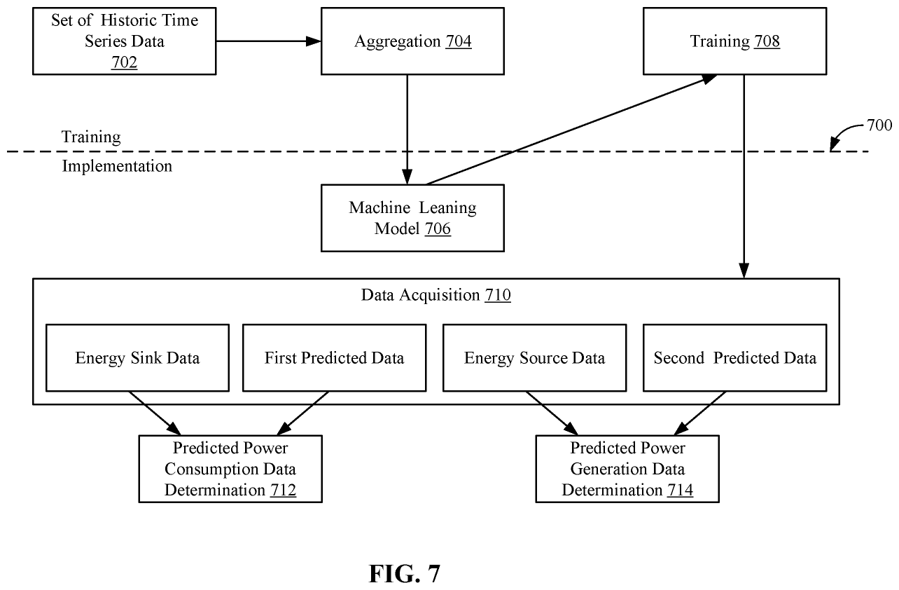

In an embodiment of the present disclosure, the predicted power consumption data may indicate at least the anticipated solar energy consumption amount for the one or more energy sink nodes 206 on a predicted sunny day. In some embodiments, the first predicted data (explained in FIG. 7) may indicate predicted weather conditions, for example, the predicted sunny day.

In another embodiment of the present disclosure, the predicted power consumption data may indicate the anticipated energy consumption amount that the facility may consume to provide the one or more services to the one or more consumers.

In an embodiment of the present disclosure, the data module 402 may obtain predicted power generation data for each one or more energy source nodes 204. Further, the predicted power generation data indicate at least an anticipated energy generation amount for each one or more energy source nodes 204.

In an embodiment of the present disclosure, the predicted power generation data may indicate at least an anticipated solar energy generation amount for each one or more energy source nodes 204 on the predicted sunny day.

In another embodiment of the present disclosure, the predicted power generation data may indicate at least the anticipated energy generation amount that may be distributed to the facility to provide the one or more services to the one or more consumers.

In some embodiment, the data module 402 may perform pre-processing on at least one of the real time power generation data, the real time power consumption data, the predicted power consumption data, and the predicted power generation data.

The data module 402 may utilize one or more pre-processing techniques. The one or more pre-processing techniques include, but are not limited to, data conversion techniques, data cleaning techniques, data validation techniques. The data conversion techniques may employ one or more data conversion algorithms to perform data conversion on at least one of the real time power generation data, the real time power consumption data, the predicted power consumption data, and the predicted power generation data. The data conversion algorithms may identify and parse in one or more data formats. In some embodiments, the data conversion algorithms may change one data format to a different data format. The data conversion may allow an integration and a utilization of the converted data across one or more systems.

Further, the data cleaning techniques may employ one or more data cleaning algorithms to perform data cleaning on the real time power generation data, the real time power consumption data, the predicted power consumption data, and/or the predicted power generation data. The data cleaning algorithms may remove a noise, artifacts, and an inference from the converted data.

In an embodiment of the present disclosure, the prediction module 404 may determine predicted allocation data corresponding to at least one of the one or more energy source nodes 204 based on at least one of the predicted power consumption data, and the predicted power generation data. The predicted allocation data comprises identification data of the at least one energy source node from the one or more energy source nodes 204. The predicted allocation data further comprises the energy amount to be drawn from the at least one energy source node associated with the identification data.

In an embodiment of the present disclosure, based on at least one of (i) the anticipated solar energy consumption amount for the one or more energy sink nodes 206 and (ii) the anticipated solar energy generation amount for each one or more energy source nodes 204 on the predicted sunny day, the prediction allocation data may be determined. Further, the prediction allocation data may comprise the identification data of the at least one energy source node of the one or more energy source nodes 204, for example, the energy source node 204A that generate the energy based on the solar energy. Further, the predication data further comprise the energy amount to be drawn from the energy source node 204A on the predicted sunny day.

In another embodiment of the present disclosure, based on the at least one of (i) the anticipated energy consumption amount that the facility may consume, and (ii) the anticipated energy generation amount that may be distributed to the facility, the prediction allocation data may be determined. Further, the prediction allocation data may further comprise the identification data of the at least one energy source node of the one or more energy source nodes 204, for example, the energy source node 204C that may correspond to a dedicated energy source node to generate the energy for the facility. Further, the prediction data further comprises data regarding the energy amount to be drawn from the energy source node 204C.

Further, in some embodiments, the prediction module 404 may employ one or more machine learning models to determine the predicted allocation data. The prediction module 404 may provide at least one of the predicted power consumption data, and the predicted power generation data to the one or more machine learning models as an input. In an embodiment of the present disclosure, the one or more machine learning models may determine the predicted allocation data by solving an allocation problem as a linear objective function to constraints, for example, an energy source node availability constraint, a grid capacity constraint, a cost minimization constraint, a renewable energy goal constraint, an environmental emission constraint, an energy source utilization constraint, a time-of-use constraint, a battery storage constraint, and the like.

In an embodiment of the present disclosure, the one or more machine learning models may utilize time series analysis techniques, for example, an auto regression integrated moving average technique, a seasonal decomposition technique, and the like to determine the predicted allocation data. Further, in some embodiments, the one or more learning models may utilize one or more forecasting algorithms to determine the predicted allocation data. The one or more forecasting algorithms may include, but are not limited to, an exponential smoothing algorithm, a hot-winter algorithm, and the like.

In an embodiment of the present disclosure, the energy optimization module 406 may determine actual allocation data corresponding to the at least one of the one or more energy source nodes 204 based on the real time power consumption data, the real time power generation data, the predicted power consumption data, and the predicted power generation data. Further, the actual allocation data comprises time data indicative of an optimal time to control at least one of the energy amount to be drawn from the at least one energy source node and the excess energy amount to be drawn from the at least one energy sink node.

In an embodiment of the present disclosure, the energy sink location data of the energy sink data may indicate a cloudy day on the predicted sunny day. As a result, an actual solar generation amount on the cloudy generated by the one or more energy source nodes 204 on the cloudy day may be less corresponding to the anticipated solar energy generation amount. Hence, the energy optimization module 406 may determine the actual allocation data to provide the constant energy supply to the one or more energy sink nodes 206. In some embodiments, the energy optimization module 406 may determine the actual allocation data based on real time power consumption data, and the real time power generation data. Further, the real time power consumption data may indicate a real time solar energy consumption on the cloudy day. The real time power generation day may indicate a real time solar energy generation on the cloudy day.

Further, the energy optimization module 406 may select based on the identification data, a different energy source node, for example, the energy source node 204D that may generate the energy based on the wind power. Further, the actual allocation data comprises the time data indicative of the optimal time to control the energy amount to be drawn from the energy source node 204D. Additionally or alternatively, the energy optimization module 406 may select a plurality of different source nodes to provide the constant energy supply to the one or more energy sink nodes 206.

In another embodiment of the present disclosure, the conditional level consumption data may indicate a decrease in the number of consumers in the facility. As a result, an actual consumption energy amount in the facility may be less corresponding to the anticipated energy amount. Hence, the energy optimization module 406 may determine the actual allocation data to feed the excess energy amount to the one or more distribution nodes 208. In some embodiments, the energy optimization module 406 may determine the actual allocation data based on real time power consumption data, and the real time power generation data. Further, the real time power consumption data may indicate a real time energy consumption amount corresponding to the facility. The real time power generation day may indicate a real time energy generation amount corresponding to the energy source node 204C.

Further, the energy optimization module 406, based on the identification data, may select at least one energy sink node, for example, the facility. Further, the actual allocation data comprises the time data indicative of the optimal time to control the excess energy amount to be drawn from the at least one energy sink node, for example, the facility. Additionally, or alternatively, the energy optimization module 406, based on the identification data, may select a plurality of sink nodes that may consume less energy corresponding to the generated energy.

In some embodiments, the environmental impact data may indicate a negative environmental impact associated with the one or more non-renewable energy source nodes. The negative environmental impact may include, but is not limited to, an excessive greenhouse gas emission, air pollution, water pollution, oil spills, radioactive hazards, and the like. Hence, the energy optimization module 406 may further determine the actual allocation data to reduce the negative environmental impact associated with the one or more non-renewable energy source nodes.

In an embodiment of the present disclosure, the environmental impact data may indicate the excessive greenhouse gas emission due to an excess usage of the coal at the location of the one or more energy source nodes 204, for example, the energy source node 204B that may correspond to the coal plant. Hence, the energy optimization module 406 may determine the actual allocation data to reduce the excessive greenhouse gas emission by selecting the at least one of the one or more renewable energy source nodes that may generate the energy based on the renewable resources and provide the constant energy supply to the one or more energy sink nodes 206. In some embodiments, the energy optimization module 406 may determine the actual allocation data based on the real time power generation data and the real time power consumption data. The real time power generation data may indicate a real time renewable energy generation amount corresponding to the one or more renewable energy source nodes. The real time power consumption data may indicate a real time non-renewable energy consumption amount corresponding to the one or more sink nodes 206. Additionally, or alternatively, the energy optimization module 406 may apply environmental impact constraints on the real time power generation data, and the real time power consumption data. The environmental impact constraints may include, but are not limited to, the renewable energy goal constraint, the environmental emission constraint, the energy source utilization constraint, and the like.

Further, the energy optimization module 406, based on the identification data, may select the at least one of the one or more renewable energy source nodes, for example, the energy source node 204A that may generate the energy based on the solar energy. Further, the actual allocation data comprises the time data indicative of the optimal time to control the energy amount to be drawn from the energy source node 204A.

In an embodiment of the present disclosure, the energy optimization module 406 may employ an optimization model to determine the actual allocation data corresponding to the at least one of the one or more energy source nodes 204 based on the real time power consumption data, the real time power generation data, the predicted power consumption data, and the predicted power generation data. Specifically, the optimization model, may determine the actual allocation data by updating the predicted allocation data based on the at least one of the real time power consumption data, the real time power generation data, the predicted power consumption data, and the predicted power generation data.

In an embodiment of the present disclosure, the energy optimization model may correspond to an unconstrained multi-variable optimization model. Further, the unconstrained multi-variable optimization model may use one or more unconstrained multi-variable optimization method to determine the actual allocation data. The one or more unconstrained multi-variable optimization methods include, but are not limited to, an ordinary least squares (OLS) regression method, a gradient descent (GD) method, a stochastic gradient descent (SGD) method, a mean-variance optimization method, an elder-mead method, a grid search method, a random search method, a bayesian optimization method, and the like.

Further, in an embodiment of the present disclosure, the energy optimization module 406 may apply a deterministic set of rules on at least one of the predicted power consumption data, the predicted power generation data, the real time power consumption data, and the real time power generation data to determine the actual allocation data. Further, the deterministic set of rules is event driven based on variables associated with a decision tree and/or a table. The variables may include, but are not limited to, a battery capacity, the predicted power generation data, and the predicted power consumption data.

In an embodiment of the present disclosure, based on a determination that the battery capacity of a battery associated with the at least one energy sink node, for the example, the energy sink node 206A is above a pre-determined level, the energy optimization model may prioritize a charging of the battery by adjusting the energy distribution operations. Specifically, the energy optimization model 406, based on the actual allocation data, may select at least one of the one or more energy source nodes 204 and determine an energy amount to be drawn from the at least one of the one or more energy source node 204 to complete the charging of the battery. Hence, by prioritizing charging of the battery, the energy optimization model 406 may provide for efficient energy utilization and energy nodes allocation.

In an embodiment of the present disclosure, the energy flow control module 408 may generate, based on the actual allocation data, a first control signal for the at least one energy source node 204 associated with the identification data. Specifically, the energy flow control module 408 may generate the first control signal to control the energy amount to be drawn from the at least one energy source node associated with the identification data. In some embodiments, the energy flow control module 408 may provide the first control signal to a controller and/or an inventor to control the energy amount to be drawn from the at least one energy source node associated with the identification data.

In an embodiment of the present disclosure, the energy control module 408 may generate, based on the actual allocation data, the first control signal for the energy source node 204D that generated energy based on the wind power. Further, the energy flow control module 408 may generate the first control signal to control the energy amount to be drawn from the energy source node 204D on the cloudy day. In an embodiment of the present disclosure, the energy source node 204D is coupled to a corresponding energy node controller 302. Further, the processing component 304 may receive the first control signal generated by the energy flow control module 408. Further, based on the first control signal, the processing component 304 may control the energy amount generated by the operational component 310, for example, a wind turbine.

In another embodiment of the present disclosure, the energy flow control module 408 may generate a second control signal corresponding to at least one energy sink node of the one or more energy sink nodes 206 based on the allocation data. Further, the energy flow control module 408 may control the excess energy amount to be drawn from the at least one energy sink node of the one or more energy sink nodes 206.

In an embodiment of the present disclosure, the energy flow control module 408 may generate, based on the actual allocation data, the second control signal for the at least one energy sink node, for example, the facility. Specifically, the energy flow control module 408 may generate the second control signal to control the excess energy amount to be drawn from the facility. In an embodiment of the present disclosure, the energy flow control module 408, based on the generated second control signal, distribute the excess energy amount to the at least one of the one or more distribution nodes 208, for example, the distribution node 208A. Further, in an embodiment of the present disclosure, the energy flow control module 408, based on the generated second control signal, distribute the excess energy amount to a different energy sink node, for example, the energy sink node 206D.

In an embodiment of the present disclosure, the energy flow control module 408 may generate, based on the actual allocation data, a third control signal for the at least one of the one or more renewable energy source nodes, for example, the energy source node 204A that may generate the energy based on the solar energy. Specifically, the energy flow control module 408 may generate the third control signal to control the energy amount to be drawn from the energy source node 204A. In an embodiment of the present disclosure, the energy flow control module 408, based on the generated third control signal, distribute the energy amount to the one or more energy sink nodes 206 to decrease an energy supply dependency on the one or more non-renewable energy source nodes, for example, the energy source node 204B that may generate the energy based on the coal. As a result, the energy flow control module 408 may decrease the negative environmental impact associated with the one or more non-renewable energy source nodes.

In an embodiment of the present disclosure, the system 202 may determine, at different times of the day, an energy price corresponding to the energy amount to be drawn from the at least one energy source node associated with the identification data. Further, the system 202 may generate, based on the energy price, and the real consumption data, an energy bill report to at least one energy consumer associated with the at least one energy sink node. Further, the energy bill report includes at least one of a predetermined time period energy usage bill, and a total energy usage bill.

Referring back to FIG. 4, the system 202 may include the improved energy flow control code block 120B for the energy flow control. The improved energy flow control code block 120B may include one or more processing modules, such as the data module 402, the prediction module 404, the energy optimization module 406, and the energy flow control module 408. The data module 402 may obtain the real time power generation data for each of one or more energy source nodes 204. Further, the data module 402 may obtain the real time power consumption data for one or more energy sink nodes. Further, the data module 402 may obtain the predicted power consumption data for the one or more energy sink nodes 206. Further, the data module 402 may obtain the predicted power generation data for each of the one or more energy source nodes 204. Further, the prediction module 404 may determine the predicted allocation data corresponding to at least one of the one or more energy source nodes 204 based on at least one of the predicted power consumption data, and the predicted power generation data. Further, the energy optimization module 406 may determine the actual allocation data corresponding to the at least one of the one or more energy source nodes 204 based on the real time power consumption data, the real time power generation data, the predicted power consumption data, and the predicted power generation data. Further, the energy flow control module 408 may generate, based on the actual allocation data, the first control signal for the at least one energy source node associated with the identification data.

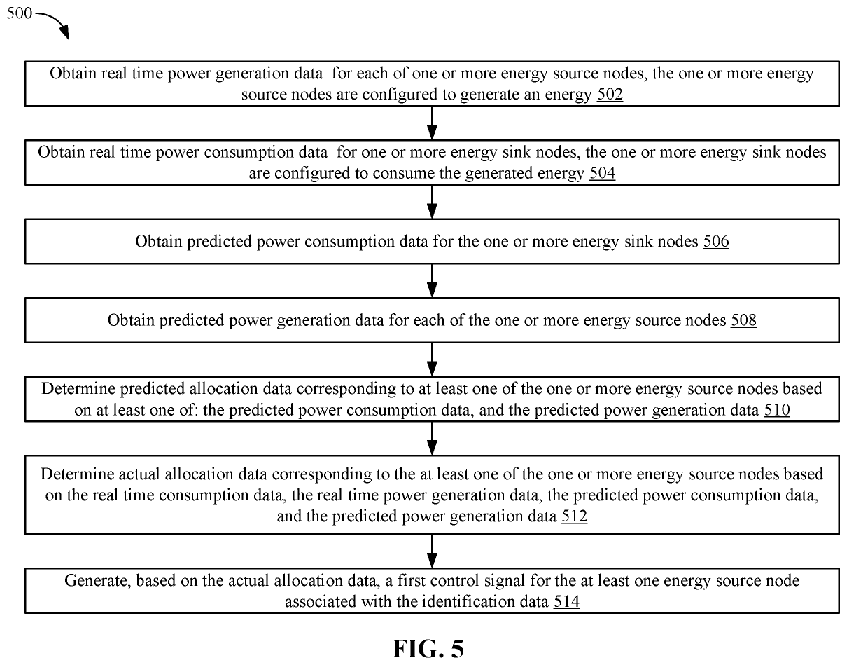

FIG. 5 is a flowchart for implementation of an exemplary method 500 for the energy flow control, in accordance with one or more example embodiments. In one or more embodiments of the present disclosure, the system 202 may perform one or more portions of the method 500 and may be implemented by, for instance, the processor set 114. As such, the system 202 may provide means for accomplishing embodiments of other processes described herein in conjunction with other components of the system 202. Although the method 500 is illustrated as a sequence of steps, its contemplated that various embodiments of the method 500 may be performed in any order or combination and need not include all of the illustrated steps.

At 502, the real time power generation data for each of one or more energy source nodes 204 is obtained. Further, the one or more energy source nodes 204 are configured to generate the energy. In some embodiments, the real time power generation data may be obtained from the one or more sensors associated with the one or more energy source nodes 204 in real time. In some embodiments, the real time power generation data may be obtained from the database associated with the system 202. In some embodiments, the real time power generation data may be obtained from a cloud. In some embodiments, the real time power generation data may be obtained from a third party provider, for example, a weather data service provider. In some embodiments, the real time power generation data may be obtained by using an application programming interface (API) or web services.

In an embodiment of the present disclosure, the real time power generation data may indicate the real time power energy generation amount of the at least one energy source node, for example, the energy source node 204C that may generate the energy for the facility.

At 504, the real time power consumption data for one or more energy sink nodes 206 is obtained. Further, the one or more energy sink nodes 206 are configured to consume the generated energy. In some embodiments, the real time power consumption data may be obtained from the one or more sensors associated with the one or more energy sink nodes 206 in real time. Further, the real time power consumption data may be obtained by aforementioned methods used for the real time power generation data.

In an embodiment of the present disclosure, the real time power consumption data may indicate the real time power consumption amount that the one or more consumers may consume at the facility.

At 506, the predicted power consumption data for the one or more energy sink nodes 206 is obtained. In some embodiments, the predicted power consumption data may be obtained from the database associated with the system 202. Further, the predicted power consumption data may be obtained by aforementioned methods used for the real time power generation data.

In an embodiment of the present disclosure, the predicted power consumption data may indicate the anticipated energy consumption amount that the one or more consumers may consume at the facility.

At 508, the predicted power generation data for each of the one or more energy source nodes 204 is obtained. In some embodiments, the predicted power generation data may be obtained from the database associated with the system 202. Further, the predicted power generation data may be obtained by aforementioned methods used for the predicted power generation data.

In an embodiment of the present disclosure, the predicted power generation data may indicate the anticipated energy generation amount that the at least one energy source node, for example, the energy source node 204C may generate for the one or more consumers at the facility.

At 510, the predicted allocation data corresponding to at least one of the one or more energy source nodes 204 based on at least one of the predicted power consumption data, and the predicted power generation data is determined. The predicted allocation data may comprise identification data of at least one energy source node from the one or more energy source nodes 206. Further, the prediction allocation may comprise the energy amount to be drawn from the at least one energy source node associated with the identification data.

In an embodiment of the present disclosure, the predicted allocation data may be determined based on the at least one of (i) the anticipated energy consumption amount that the one or more consumers may consume at the facility, and (ii) the anticipated energy generation amount that the at least one energy source node, for example, the energy source node 204C, may generate for the one or more consumers at the facility. Further, the prediction allocation data may comprise identification data of the energy source node 204C. Further, the prediction allocation may comprise the energy amount to be drawn from the energy source node 204C associated with the identification data.

At 512, the actual allocation data corresponding to the at least one of the one or more energy source nodes 204 based on the real time power consumption data, the real time power generation data, the predicted power consumption data, and the predicted power generation data is determined.

In an embodiment of the present disclosure, the conditional level consumption data may indicate the increase in the number of consumers at the facility. As a result, the facility may require the additional energy amount to provide one or more services to the one or more consumers. Hence, in some embodiments, the actual allocation data may be determined based on the at least one of (i) the real time power energy generation amount of the energy source node 204C that may generate the energy for the facility, and (ii) real time power consumption amount that the one or more consumers may consume at the facility.

Further, the actual allocation data may comprise the time data indicative of the optimal time to control the energy amount to be drawn from the at least one energy source node, for example, the energy source node 204A.

At 514, based on the actual allocation data, the first control signal for the at least one energy source node associated with the identification data is generated. Further, based on the generated first control signal, the energy amount to be drawn from the at least one energy source node associated with the identification data is controlled.

In an embodiment of the present disclosure, based on the actual allocation data, the first control signal may be generated for the energy source node 204A that may generate the energy based on the solar energy. Further, based on the generated control signal, the energy amount to be drawn from the energy source node 204A may be controlled.

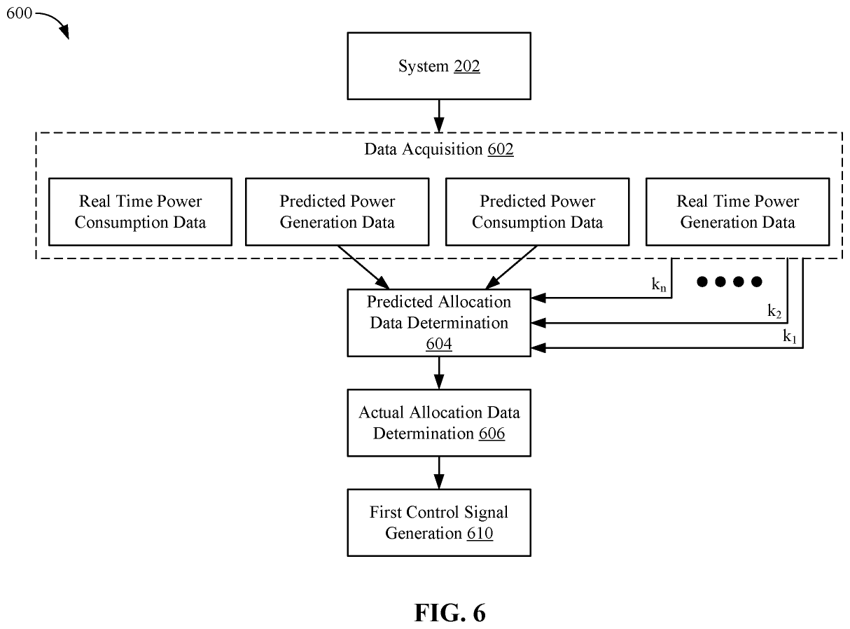

Further, in some embodiments, the system 202 may optimize the predicted allocation data by updating the predicted allocation data at periodic intervals. Such implementation of the system 202 is described with reference to FIG. 6.

FIG. 6 is a block diagram 600 illustrating an example embodiment of the system 202 for the energy flow control, in accordance with one or more example embodiments. As shown in FIG. 6, the system 202 may perform the data acquisition 602. The data acquisition 602 include the acquiring of the real time power consumption data, the predicted power generation data, the predicted power consumption data, and the real time power generation data.

Further, in an embodiment of the present disclosure, the system may determine 604 the predicted allocation data based on the at least one of the predicted power consumption data, and the predicted power consumption data.

Further, the system may perform the data acquisition 602 at periodic intervals, for example, a periodic interval k₁, a periodic interval k₂, and a periodic interval kₙ. In some embodiments, a duration between the periodic intervals is same. In some embodiments, the duration between the periodic intervals is different. Further, in some embodiments, the system 202 may determine 604 the actual allocation data based on the real time power consumption data, the real time power generation data, the predicted power consumption data, and the predicted power generation data. In an embodiment of the present disclosure, the system 202 may use the optimization model, to determine 606 the actual allocation data by updating predicted allocation data, at the periodic intervals, based on the predicted power consumption data, the predicted power generation data, the real time power consumption data, and the real time power generation data corresponding to the at least one of the one or more energy source nodes 204. In some embodiments, the system 202 may generate 610, the first control signal to control the drawn energy of the at least one energy source node.

In some embodiments, the system 202 may determine, using a trained machine learning model, the at least one of the predicted power consumption data, and the predicted power generation data. A training of such machine learning model is described below with reference to FIG. 7.

FIG. 7 is a diagram that illustrates an example embodiment of a training 708 of a machine learning model 706 used for at least one of determination 712 of predicted power consumption data, and determination 714 of predicted power generation data, in accordance with one or more example embodiments. As shown, there is a training portion above line 700 and an implementation portion below line 700. The set of historic time series data 702 include at least one of historic power generation data, historic power consumption data, historic weather data, and historic conditional level consumption data.

Further, the historic set of time series data 702 is aggregated 704 to predict the power consumption data, and the power generation data. Further, after aggregation 704, the historic set of time series data 702 is provided to the machine learning model 706 for the training 708 of the machine learning model 706. In some embodiments, the trained machine learning model may correspond to at least one of a multivariate time series model, and a vector auto regression model.

Further, in the implementation phase, data acquisition 710 is performed. In some embodiments, the data acquisition 710 may include obtaining the energy sink data corresponding to the at least one energy sink node, for example, the energy sink node 206A of the one or more energy sink nodes 206. In an embodiment of the present disclosure, the system 202 may obtain the energy sink data corresponding to the energy sink node 206A from the memory 306 of the energy node controller 302. The data acquisition 710 may further include obtaining first predicted data corresponding to the at least one energy sink node of the one or more energy sink nodes 206. Further, the first predicted data include at least one of predicted first weather data and predicted conditional level consumption data. The predicted first weather data may indicate anticipated weather conditions associated with the location of the one or more energy sink nodes 206.

Further, in some embodiments, the data acquisition 710 may further include obtaining the energy source data corresponding to the at least one energy source node, for example, the energy source node 204A of the one or more energy source nodes 204. In an embodiment of the present disclosure, the system 202 may obtain the energy source data corresponding to the energy source node 204A from the memory 306 of the energy node controller 302. The data acquisition 710 may further include obtaining second predicted data corresponding to the at least one energy source node of the one or more energy source nodes 204. Further, the second predicted data include at least predicted second weather data. The predicted second weather data indicate anticipated weather conditions associated with the location of the one or more energy source nodes 204.

Further, in an embodiment of the present disclosure, the trained machine learning model 706 may be used to determine 712 the predicted power consumption data based on the at least one of the energy sink data, and the first predicted data. Further, in an embodiment of the present disclosure, the trained machine learning model 706 may be used to determine 714 the predicted power generation data based on the least one of the energy source data, and the second predicted data.

In some embodiments, the system 202 may perform data acquisition 710, at periodic intervals, to update a training dataset. Specifically, the system may obtain, at the periodic intervals, the at least one of the energy sink data, the first predicted data, the energy source data, and the second predicted data to update the training dataset. Further, the system 202 may re-train the machine learning model 706 based on the updated training dataset, and the historic set of time series data 702.

Further, the machine learning module 706 may be re-trained using one or more re-training techniques. The one or more re-training techniques may include, but are not limited to, batch re-training techniques, active learning re-training techniques, incremental learning re-training techniques, transfer learning re-training techniques, reinforcement learning policies re-training techniques, ensemble method re-training techniques, data augmentation re-training techniques, adaptive learning rates re-training techniques, and the like.

Various embodiments of the disclosure may provide a non-transitory computer readable medium and/or storage medium having stored thereon, instructions executable by a machine and/or a computer to operate a system (e.g., the system 202) for the energy flow control. The instructions may cause the machine and/or computer to perform operations that include obtaining real time power generation data for each of one or more energy source nodes, the one or more energy source nodes are configured to generate energy. The operation further include obtaining real time power consumption data for one or more energy sink nodes, the one or more energy sink nodes are configured to consume the generated energy. The operation further includes obtaining predicted power consumption data for the one or more energy sink nodes. The operation further includes obtaining predicted power generation data for each of the one or more energy source nodes. The operation further includes determining predicted allocation data corresponding to at least one of the one or more energy source nodes based on at least one of the predicted power consumption data, and the predicted power generation data, the predicted allocation data comprising: (i) identification data of at least one energy source node from the one or more energy source nodes, and (ii) an energy amount to be drawn from the at least one energy source node associated with the identification data. The operation further includes determining actual allocation data corresponding to the at least one of the one or more energy source nodes based on the real time power consumption data, the real time power generation data, the predicted power consumption data, and the predicted power generation data. The operation further includes generating, based on the actual allocation data, a first control signal for the at least one energy source node associated with the identification data.

The descriptions of the various embodiments of the present disclosure have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer implemented method comprising:
obtaining real time power generation data for each of one or more energy source nodes, the one or more energy source nodes are configured to generate energy;
obtaining real time power consumption data for one or more energy sink nodes, the one or more energy sink nodes are configured to consume the generated energy;
obtaining predicted power consumption data for the one or more energy sink nodes;
obtaining predicted power generation data for each of the one or more energy source nodes;
determining predicted allocation data corresponding to at least one of the one or more energy source nodes based on at least one of: the predicted power consumption data, and the predicted power generation data, the predicted allocation data comprising: (i) identification data of at least one energy source node from the one or more energy source nodes, and (ii) an energy amount to be drawn from the at least one energy source node associated with the identification data;
determining actual allocation data corresponding to the at least one of the one or more energy source nodes based on the real time power consumption data, the real time power generation data, the predicted power consumption data, and the predicted power generation data; and
generating, based on the actual allocation data, a first control signal for the at least one energy source node associated with the identification data.

2. The computer implemented method of claim 1, further comprising controlling, based on the generated first control signal, an energy amount to be drawn from the at least one energy source node associated with the identification data.

3. The computer implemented method of claim 1, further comprising determining, at periodic intervals, the actual allocation data based on the real time power consumption data, the real time power generation data, the predicted power consumption data, and the predicted power generation data.

4. The computer implemented method of claim 1, further comprising:
generating, based on the actual allocation data, a second control signal for at least one energy sink node of the one or more energy sink nodes; and
controlling, based on the generated second control signal, an excess energy amount to be drawn from the at least one energy sink node of the one or more energy sink nodes.

5. The computer implemented method of claim 4, wherein the actual allocation data comprises time data indicative of an optimal time to control at least one of: the energy amount to be drawn from the at least one energy source node and the excess energy amount to be drawn from the at least one energy sink node.

6. The computer implemented method of claim 1, further comprising determining, using a trained machine learning (ML) model, at least one of: the predicted power consumption data, and the predicted power generation data, wherein the ML model is trained based on a set of historic time series data, the set of historic time series data include at least one of: historic power generation data, historic power consumption data, historic weather data, and historic conditional level consumption data.

7. The computer implemented method of claim 6, wherein the trained ML model corresponds to at least one of: a multivariate time series model, and a vector auto regression model.

8. The computer implemented method of claim 6, further comprising:
obtaining, energy sink data corresponding to the at least one energy sink node of the one or more energy sink nodes, the energy sink data include at least one of:
energy sink type data, energy sink power consumption capacity data, energy sink location data, and conditional level consumption data;
obtaining, first predicted data corresponding to the at least one energy sink node of the one or more energy sink nodes, the first predicted data include at least one of: predicted first weather data, and predicted conditional level consumption data; and
determining using the trained ML model, the predicted power consumption data based on at least one of: the energy sink data, and the first predicted data.

9. The computer implemented method of claim 6, further comprising:
obtaining, energy source data corresponding to the at least one energy source node of the one or more energy source nodes, the energy source data include at least one of: energy source type data, energy source power generation capacity data, energy source installation data, and environmental impact data;
obtaining, second predicted data corresponding to the at least one energy source node of the one or more energy source nodes, the second predicted data include at least predicted second weather data; and
determining, using the trained ML model, the predicted power generation data based on at least one of: the energy source data and the second predicted data.

10. The computer implemented method of claim 1, further comprising determining, by using an optimization model, the actual allocation data by updating the predicted allocation data based on at least one of: the predicted power consumption data, the predicted power generation data, the real time power consumption data, and the real time power generation data corresponding to the at least one of the one or more energy source nodes.

11. The computer implemented method of claim 10, wherein the optimization model corresponds to an unconstrained multi-variable optimization model.

12. The computer implemented method of claim 1, further comprising determining the actual allocation data by applying a deterministic set of rules on at least one of: the predicted power consumption data, the predicted power generation data, the real time power consumption data, and the real time power generation data.

13. The computer implemented method of claim 1, further comprising:
determining, at different times of day, an energy price corresponding to the energy amount to be drawn from the at least one energy source node associated with the identification data; and
generating, based on the energy price and the real time power consumption data, an energy bill report to at least one energy consumer associated with the at least one energy sink node, the energy bill report includes at least one of: a predetermined time period energy usage bill, and a total energy usage bill.

14. A system, comprising:
processing circuitry configured to:
obtain real time power generation data for each of one or more energy source nodes, the one or more energy source nodes are configured to generate energy;
obtain real time power consumption data for one or more energy sink nodes, the one or more energy sink nodes are configured to consume the generated energy;
determine predicted power consumption data for the one or more energy sink nodes based on at least one of: energy sink data, and first predicted data;
determine predicted power generation data for each of one or more energy source nodes based on at least one of: energy source data, and second predicted data;
determine predicted allocation data corresponding to at least one of the one or more energy source nodes based on at least one of: the predicted power consumption data, the predicted power generation data, the predicted allocation data comprising: (i) identification data of at least one energy source node from the one or more energy source nodes, and (ii) an energy amount to be drawn from the at least one energy source node associated with the identification data;
determine actual allocation data corresponding to the at least one of the one or more energy source nodes based on the real time power consumption data, the real time power generation data, the predicted power consumption data, and the predicted power generation data; and
generate, based on the actual allocation data, a first control signal for the at least one energy source node associated with the identification data.

15. The system of claim 14, wherein the processing circuitry is further configured to control, based on the generated first control signal, the energy amount to be drawn from the at least one energy source node associated with the identification data.

16. The system of claim 14, wherein the processing circuitry is further configured to determine, at periodic intervals, the actual allocation data based on the real time power consumption data, the real time power generation data, the predicted power consumption data, and the predicted power generation data.

17. The system of claim 14, wherein the processing circuitry is further configured to:
generate, based on the actual allocation data, a second control signal for at least one energy sink node of the one or more energy sink nodes; and
control, based on the generated second control signal, an excess energy amount to be drawn from the at least one energy sink node of the one or more energy sink nodes.

18. The system of claim 17, wherein the actual allocation data comprises time data indicative of an optimal time to control at least one of: the energy amount to be drawn from the at least one energy source node and the excess energy amount to be drawn from the at least one energy sink node.

19. The system of claim 14, wherein the processing circuitry is further configured to determine the actual allocation data based on at least one of: an optimization model, and a deterministic set of rules.

20. A computer program product for energy flow control, the computer program product comprising a computer readable storage medium having program instructions embodied therewith, the program instructions executed by a system to cause the system to:
obtaining real time power generation data for each of one or more energy source nodes, the one or more energy source nodes are configured to generate energy;
obtaining real time power consumption data for one or more energy sink nodes, the one or more energy sink nodes are configured to consume the generated energy
obtaining predicted power consumption data for the one or more energy sink nodes;
obtaining predicted power generation data for each of one or more energy source nodes;
determining predicted allocation data corresponding to at least one of the one or more energy source nodes based on at least one of: the predicted power consumption data, and the predicted power generation data, the predicted allocation data comprising: (i) identification data of at least one energy source node from the one or more energy source nodes, and (ii) an energy amount to be drawn from the at least one energy source node associated with the identification data;
determining actual allocation data corresponding to the at least one of the one or more energy source nodes based on the real time power consumption data, the real time power generation data, the predicted power consumption data, and the predicted power generation data; and
generating, based on the actual allocation data, a first control signal for the at least one energy source node associated with the identification data.
